(19) United States
(12) Patent Application Publication
(10) Pub. No.: US 2009/0285946 A1
(43) Pub. Date: Nov. 19, 2009

(54) HIGH FIBER SHREDDED CEREAL AND METHOD OF PREPARATION

(76) Inventors: Terry T. Kirihara, Bloomington, MN (US); Jonathan E. Trautz, Maple Grove, MN (US)

Correspondence Address: GENERAL MILLS, INC., P.O. BOX 1113, MINNEAPOLIS, MN, 55440, US

(21) Appl. No.: 12/368,581

(22) Filed: Feb. 10, 2009

Related U.S. Application Data
(60) Provisional application No. 61/053,370, filed on May 15, 2008.

(51) Int. Cl. A23L 1/10; A23L 1/00

(52) U.S. Cl. 426/96; 426/523; 426/283; 426/618

(57) ABSTRACT

Improved high fiber shredded whole wheat cereal biscuits and their methods of preparation are provided. The methods include adding finely milled bran to tempered cooked whole wheat berries to form a blend. Masa (corn) bran is preferred. The methods include thereafter shredding the bran fiber fortified cooked whole wheat berries to form shredded mats and then forming the shredded mats into desired shaped and sized finished breakfast cereal pieces such as bite sized biscuits or nuggets. By adding the finely milled bran immediately prior to shredding, high levels of fiber fortification can be obtained while avoiding minimizing bran-speckled finished products.

### CROSS-REFERENCE TO RELATED APPLICATIONS

This application claims the benefit of priority under 35 U.S.C. 119(e)(1) of a provisional patent application Ser. No. 61/053,370, filed May 15, 2008, which is incorporated herein by reference in its entity.

### FIELD OF THE INVENTION

The present invention relates to food products and to their methods of preparation. In particular, the present invention relates to breakfast cereal food products prepared from cooked wheat berries, especially high fiber shredded wheat ready-to-eat or breakfast cereals biscuit pieces and to their methods of preparation.

### BACKGROUND OF THE INVENTION

The present invention is an improvement upon shredded wheat cereal biscuits and their methods of preparation. More specifically, the present invention provides methods for preparing high fiber shredded wheat breakfast cereal biscuits and to the high fiber shredded wheat breakfast cereal products provided therefrom especially those having high levels of insoluble fiber of cereal origin.

Invented by Henry Perkey in 1893, shredded wheat breakfast cereals are well known. Shredded Wheat is a breakfast cereal made from whole wheat. It generally comes in two sizes, bite or spoon sized (¾ in×1 in) referred to as biscuits, and normal size, which are sometimes broken into small pieces before adding milk.

To prepare shredded wheat, whole wheat berries are first cooked in water until their moisture content reaches ≈50%. The cooked hydrated wheat berries are cooled and then tempered, allowing moisture to diffuse evenly into the grain. In known and conventional processes for manufacturing a whole wheat food product, tempering of the cooked whole wheat is commonly carried out by holding the wheat at ambient pressure and temperature, e.g., from ≈15° C.-30° C. for a period of from 8-28 hours. As a result of the tempering, the grain attains a uniform temperature and moisture content and the starch content thereof is sufficiently retrograded to permit effective shaping of the cooked wheat. The tempered cooked grain berries are then passed through a set of rollers with grooves in one side, yielding a web of moist or high moisture shredded wheat strands. Many webs are stacked together, and this moist stack of strands is slit and crimped at regular intervals to produce individual pieces of cereal with the strands attached at each end. These high moisture intermediates then go into an oven, where they are baked until their moisture content is reduced to ≈5%. Upon separation, individual breakfast cereal pieces are obtained. Production of such product has been made since about 1926 in the UK at Welwyn Garden City although more recently some shredded wheat is made at Staverton near Bath.

A good description of useful wheat berries cooking apparatus and methods is given in UK Pat. No 2,298,122 issued 7 Apr. 1999 “Process for cooking Cereal Grains” (See equivalently, U.S. Pat. No. 5,972,413 issued 26 Oct. 1999 to Whitney et al.).

Within this general preparation description, a wide variety of flavors and sorts of shredded wheat cereals are popular both in the UK and abroad. Often such products include an intermediate fruit paste layer and/or a topical sugar coating layer often on one or both major faces. Such products include those marketed under the brands, inter alia: Nestlé Shredded Wheat Bitesize, Nestlé Honey Nut Shredded Wheat, Nestlé Fruitful Shredded Wheat, Nestlé Clusters, Nestlé Shreddies, Nestlé Frosted Shreddies, Nestlé Coco Shreddies, Nestlé Honey Shreddies.

While popular, such products generally have fiber contents that derive only from the native fiber content of the wheat berries from which such cereal products are fabricated. However, current consumer interest resides in food products, especially breakfast cereal products that provide higher levels of fiber than native levels. Also, even the native level of fiber can be diluted when supplemental ingredients such as sugar coatings are employed. In preferred embodiments, at least a portion of the supplemental fiber is insoluble fiber such as provided by cereal brans(s).

One difficulty with adding additional dry forms of fiber such as insoluble fiber resides in difficulties in processing the cereal ingredients whilst maintaining the traditional eating and texture qualities of the finished product. For example, the cooked wheat could be formed into a cooked cereal dough that is thereafter formed into pellets and thence shredded to form shredded pieces. Fiber can be easily added to such cooked cereal doughs. However, the resultant high fiber pieces prepared from cooked cereal dough pellets while visually reminiscent of traditional shredded wheat cereal pieces generally have an untraditional eating quality.

In another approach, the insoluble fiber can be topically applied and secured to the cereal piece with a sugar binder or coating. While useful, the product can be visually unappealing and have an unacceptable flavor. Also, not all consumers prefer presweetened cereals especially those consumers interested in high fiber cereals products.

Thus, the present invention is concerned with the problems of providing shredded wheat breakfast cereal preparation techniques that provide the taste and flavor attributes of traditional shredded wheat products whilst nonetheless providing products fortified with fiber above the native fiber level of wheat. The appearance, texture and flavor problems are avoided by adding finely milled maize (corn) bran to the tempered and cooked wheat berries. Amongst all the possible fiber addition points in the traditional process, addition of cereal or bran derived insoluble fiber topically immediately prior to shredding surprisingly alone results in a visually appealing product. After gentle admixture, the bran-fortified, tempered wheat berries can be shredded and formed into finished products using traditional plant, method, and condition. The finished product enjoys traditional appearance, taste and texture notwithstanding fiber fortification.

### BRIEF DESCRIPTION OF THE DRAWING

FIG. 1 is a process flow diagram is an illustration of one embodiment of practicing the present invention.

### BRIEF SUMMARY OF THE INVENTION

The present invention resides in methods for manufacturing a whole wheat food product that comprises the steps of:
A. cooking whole wheat kernels having a starchy endosperm and native insoluble fiber content of up to ≈14% with water to at least substantially gelatinize the starchy endosperm to provide a cooked whole wheat kernels containing from ≈28%-≈55% moisture;
B. tempering the cooked whole wheat for a period of from 0-≈12 hours under ambient temperature and pressure conditions to provide tempered cooked whole wheat;
C. admixing a milled bran fiber ingredient to the tempered cooked whole wheat to provide a bran and whole wheat blend in amounts sufficient to provide an insoluble fiber content of ≈15%-40% (dry basis);
D. shaping the chilled tempered whole wheat to a desired configuration to form a shaped tempered cooked high fiber whole wheat shredded product; and
E. baking or toasting the shaped, tempered whole wheat food product to form a toasted dried high fiber whole wheat dried cereal.

In its product aspect, the present invention resides in the breakfast cereal prepared by the present methods of preparation.

### DETAILED DESCRIPTION OF THE INVENTION

The present invention is an improvement upon shredded wheat cereal biscuits and their methods of preparation. More specifically, the present invention provides methods for preparing high fiber shredded wheat breakfast cereal biscuits and to the high fiber shredded wheat breakfast cereal products provided therefrom by the addition of finely milled bran to tempered cooked whole wheat berries.

Throughout the specification and claims, percentages are by weight and temperatures in degrees Centigrade unless otherwise indicated. Each of the referenced patents and patent applications are incorporated herein by reference.

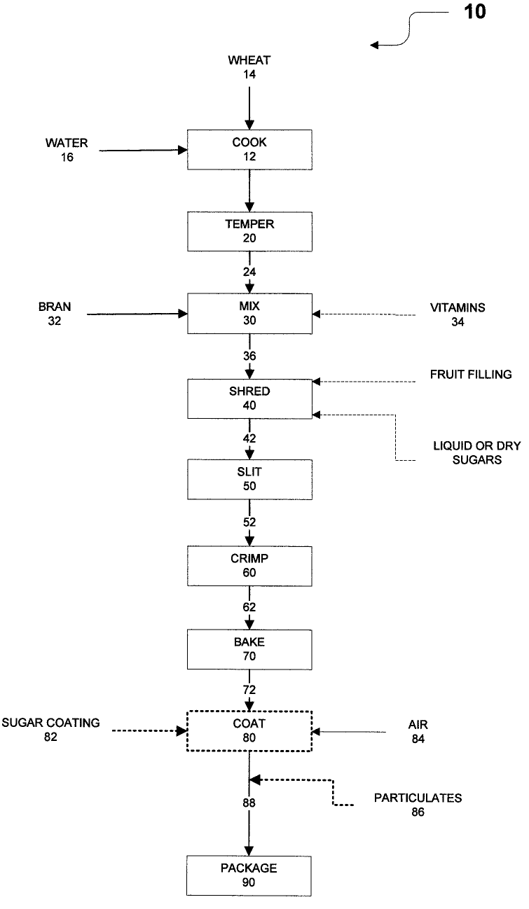

Referring now to FIG. 1, there is shown a process flow diagram generally designated by reference numeral 10. As illustrated in FIG. 1, the present methods can comprise a first step of cooking 10 whole wheat to provide cooked whole wheat.

A good description of methods and techniques for the preparation of shredded wheat cereals is given in “Breakfast Cereals and How They Are Made” by Robert Fast et al., published by the American Association of Cereal Chemists, Inc. St. Paul Minn. USA 1990 (especially pages 35-37). As therein generally described, wheat grain used in whole kernel form for shredding wheat. White wheat produces shredded wheat biscuits that are light in color with a golden brown top crust and bottom when properly baked. Red wheats can also be used for shredding but the shreds are greyer and bran specks stand out more because the bran is initially darker.

The wheat is cleaned of sticks, stones, chaff, soil and foreign material to form cleaned wheat. The cleaned wheat is cooked in batches of excess water preferably at slightly below boiling point under atmospheric pressure. The cooking step 10 is achieved and stopped when the very center of the kernel endosperm turns from starchy white to translucent grey indicating that the starchy endosperm is substantially gelatinized which usually requires ≈30-35 minutes. In some variations, the cooking step 10 can be practiced under pressure (≈14.7-45 psia.; 100-310 kPa.) at elevated temperatures (≈100° C.-130° C.) for faster cook times. The moisture content of the cooked grain at the end of the cooking step can range from ≈28-55%, preferably ≈45%-55%.

The wheat cooking step can be practiced using a batch, an atmospheric or in other low sheer cooking equipment that maintain the berries piece integrity (preferably such as described in the semi-continuous two stage cooking apparatus described in UK Patent Publication No GB2298122 dated 28 Aug. 1996; see, equivalent counterpart, U.S. Pat. No. 5,972,413 “Process For Cooking Cereal Grain” issued Oct. 26, 1999 to Whitney et al.). The wheat is cooked with steam and sufficient amounts of added water for times and at temperatures sufficient to gelatinize the cereal starch and to develop desired levels of cooked cereal flavor.

After completion of the cooking step, the water is drained from the cooker and the cooked wheat dumped and drained. As indicated in FIG. 1, the present methods 10 can comprise a step 20 of tempering the cooked whole wheat for a period of from 2-12 hours to provide tempered cooked whole wheat 24. Initially, the cooked grain is cooled to ambient temperature to stop the cooking process This cooling can be practiced by drawn air through vertical louvered units, or through horizontal vibratory perforated pans, or by conveyance belts to a temper bin or otherwise. If desired, chilled air can be employed to accelerate the cooling. Thereafter, the cooked wheat can be held in suitable storage bins or containers and allowed to temper for up to 24 hours before shredding, preferably ≈3-6 hours. In a preferred embodiment, the tempering step is practiced at under ambient temperature and pressure conditions. In certain techniques, the cooling can be continued with chilled air to reduce the cooked grain to chilled temperatures (e.g., 1-12° C.) to reduce the temper times required and thereby reduce the bulk storage requirements and thus the cost of the tempering step. The tempering step 20 allows the moisture in the cooked wheat kernels to fully equilibrate. The kernels become more firm. This firming is important to obtaining shreds of good strength for cutting and handling of the unbaked biscuits. If the tempering time is insufficient, the shreds can be cooked rather than straight as well as gummy and sticky and cannot be cut properly.

The tempered cooked whole wheat particles can then be transferred, suitably by means of belt conveyers, to a hopper that feeds a screw conveyer for conveyance to the shredding rolls.

Thereafter, methods 10 can include the step 30 of admixing a milled bran fiber ingredient 30 to the tempered cooked whole wheat 24 to provide a bran and whole wheat blend 36 in amounts sufficient to provide an insoluble fiber content of ≈15%-40% (dry basis). Whole wheat berries have a native fiber content from its bran layer constituent that typically ranges from ≈7-14% depending upon such factors as wheat variety, crop year variations, handling, bumping of the wheat prior to cooking, etc. In the present invention, finely milled grain bran 32 is admixed with the tempered cooked wheat 24 to supplement the native fiber content to desired levels generally providing a total fiber content ranging from ≈15-45%. This admixture is preferably practiced immediately prior the subsequent shredding step.

In preferred form, the milled cereal grain bran is milled to a particle size ranging from ≈20-1000 microns (μm), preferably ≈20-100 microns and for best results ≈40-60 μm. Selection of such fine particle size can be important to providing a desirable uniform color appearance in the finished pieces. Also, the fine particle size minimizes and grittiness that can occurs when larger bran particles are employed.

The bran can be provided by any common cereal grain including maize (“corn”), wheat, rye, barley, rice or mixtures thereof. Preferred for use is maize bran or bran blends comprising a majority of bran from maize and lesser amounts of, for example, wheat bran. Maize bran is preferred, especially when used in combination with white wheat. Maize bran is preferred not only for its greater availability and lower cost but also because of the color of maize bran. When used in combination with white wheat, the added bran is less visually discernable in the finished pieces adding to consumer acceptance. That is, the finished product is characterized by color uniformity in appearance and the bran particles are minimally visually discernable. Since most consumers are visually cued, the absence of a visual clue can reduce some consumer dislike of a high fiber food product. In contrast, certain known high fiber shredded wheat cereal products are defective in that the products appear mottled due to the added bran especially from added wheat bran. In preferred form, the bran is treated to improve stability such as by steam or other heat treatment.

The bran 32 can be conveniently admixed using any suitable equipment or technique. In one commercial practice, the bran is added to the screw conveyer that is employed to convey the tempered wheat 24 to the shredding rolls. It has been surprising found that addition of the bran to the screw conveyor conveniently can be used to practice this admixing step. It will be appreciated that this admixture results in a topical application of the bran to the cooked wheat berries rather than incorporation into their body.

Optionally, as depicted in FIG. 1, methods 10 can include fortifying the cooked tempered wheat/bran mixture with a variety of added ingredients 34 designed to improve the aesthetic, organoleptic or nutritional qualities of the cereal. These adjuvant materials can include vitamin and/or mineral fortification, colors, flavors, high potency sweetener(s), and mixtures thereof.

Fiber is believed to affect adversely selected mineral and vitamin absorption. Accordingly, in highly preferred embodiments, in particular, the present high fiber shredded wheat cereals can be fortified with bioavailable sources of calcium, iron, and the like. These mineral fortifiers can be incorporated into the cereal compositions directly. It is also desirable to vitamin fortify the present cereals, especially with selected B vitamins, e.g., riboflavin. Conventional methods and techniques of vitamin fortification can be used herein. The precise ingredient concentration in the present cereal composition will vary in known manner. Generally, however, such materials can each comprise ≈0.01% to ≈2% dry weight of the cereal composition. One especially useful material is common salt. Desirably, the salt comprises ≈0.1 to 2%, preferably ≈0.5 to 1.0% of the cereal composition.

Thereafter, methods 10 can broadly include the step of shaping the bran and chilled tempered cooked whole wheat blend 36 into a desired piece configuration. In preferred embodiments, this step can include the sub-steps of shredding 40 the blend 36 into a continuous mat, and forming the mat into individual biscuits. The biscuit forming operation can include slitting 50 the mat into multiple continuous longitudinally extending ribbons 54, and crimping 60 the multiple ribbons with a perpendicular or transverse crimp or seam to form crimped ribbons 52.

Moisture contents of from ≈28% to ≈49% based upon the weight of the blend 36 particles are suitable for shredding on shredding rolls. For optimum shreddability, the moisture content of the cooked, cooled, surface dried blend 36 particles should be ≈39% to ≈43% preferably ≈40% to ≈42%. These moisture contents can be achieved in the tempering step or by additional drying. Typically, the additional drying can be at temperatures in the range of from ≈15-40° C. (≈60° F.-100° F.) for ≈10 minutes down to ≈5 minutes. At moisture contents below ≈28%, shreddability of the cooked wheat particles deteriorates rapidly. The particles tend to crumble or shreds which are produced are of low strength, thereby hampering the production of long continuous shred layers on a shredding roll.

The screw conveyer transfers the blend 36 particles to a series of conventional shredding rolls or mills via flow tubes or hoppers or the like.

In the shredding step 40, the wheat kernels are squeezed between two rolls; one with a smooth surface and the other grooved. The roll pair is equipped with a comb with each tooth in a groove. As the roll revolves, the comb teeth pick the wheat shred out of the groove. The shreds are laid down on a conveyor under the rolls. Each pair of roll forms one layer of the finished biscuit.

Shredding systems which can be used in the process of the present invention can comprise conventional rolls and devices such as those indicated in U.S. Pat. Nos. 502,378, 2,008,024, 2,013,003, 4,004,035, and Canadian Patent No. 674,046. A conventional shredding mill for use in the process of the present invention comprises a pair of closely spaced rolls that rotate in opposite directions, with at least one of the rolls having circumferential grooves. Upon passing between the rolls, the wheat is deformed into long individual strings or shreds. The circumferentially grooved roll can also be grooved transversely to the circumferential grooves for the production of net-like sheets. When the rollers are held to roll in mutual contact, the shreds or filaments will be fairly separate from each other, though more or less contacting, but when the rollers are sprung slightly apart, under pressure, the adjacent filaments can be united to each other by very thin translucent, almost transparent, webs or fins between them.

The shredding mills are typically arranged in a linear series along a common conveyor, with the shreds running longitudinally or in parallel with the direction of movement of the conveyor. The sheets or layers of filaments are deposited on the conveyor with their filaments running in the same direction. A typical biscuit, for example, can contain up to 21 individual layers of shreds. These layered sheets can be cut to form spoon-size rectangular biscuits or other shapes typical of ready-to-eat breakfast cereals, biscuits or crackers

The shreds, which can be produced in the form of net-like sheets by each set of shredding rolls, are layered, cut, dried, baked, toasted, to form finished dried shelf stable RTE or breakfast cereal products and then the pieces are packaged in known.

The present preferred shredded net like sheets will have relatively few transversely extending connecting filaments. In contrast, particular grooved rolls can be selected that have roll patterns that provided a relatively high number of transversely extending connecting filaments. Such sheets are used to make a more regular grid patterned sheets. Such grid patterned sheets are popular to prepare a whole wheat product especially in the form of a pillow fabricated from a two layer pieces. While the present invention finds particular suitability for use in connection with shredded wheat breakfast cereal products, the present methods can also be advantageously used to prepare whole wheat biscuits fabricated from grid patterned sheets.

More specifically, after the mat or web of many layers of shreds reaches the end of the shredders, it is fed through one or more cutting devices to form individual pieces 62 of shaped tempered cooked high fiber whole wheat shredded product. Upon obtaining the requisite thickness, the multiple layer web can be cut and the present methods comprise a step of first slitting 50 or cutting the mat longitudinally to form multiple lines or ribbons and then comprise a step of cutting or crimping 60 the transversely into multiple ribbons or lines of biscuits in known manner. The crimping 60 step can be completely through the laminate to form the individual biscuit shapes prior to baking. Cutting partially through the laminate to form biscuit shapes, followed by baking, and then separating the baked partially cut laminate into individual biscuits in known manner is preferred for easier control of the orientation of the cut product as it passes through the baking oven. Of course, full sized traditionally shaped and sized pieces can also be fabricated.

In still other variations, the biscuits can be fabricated to include an intermediate fruit paste filling (See, for example, U.S. Pat. No. 4,795,647 “Continuous Production Of Shelf-Stable Multi-Textured Shredded Cereal Biscuits Having A Paste Filling” issued Jan. 3, 1989 or U.S. Pat. No. 4,696,825 “Continuous Production Of Shelf-Stable Multi-Textured Shredded Cereal Biscuits Having A Paste Filling” issued Sep. 29, 1987 each to Kevin Leibfred).

Thereafter, the present methods 10 can include a step of baking 70 the shaped, tempered whole wheat food product 62 to form a baked or dried or toasted high fiber whole wheat dried cereal 72. The individual biscuits are then baked in a band or continuous conveyor-oven. The oven is zoned and controlled so that the major heat imput to the biscuits is in the first few zones, a rise in the biscuit height development occurs in the middles zones along with moisture removal and color development and final moisture removal in the last few zones. Temperature profiles used in the oven for drying, baking and toasting of the high fiber wheat blends can generally be the same as those used in producing shredded wheat biscuits. A suitable temperature profile ranges from ≈315° C. (600° F.) at the entrance to the oven to ≈65° C. (150° F.) at the exit of the oven. The total time for drying, baking, and toasting ranges from ≈6-8 minutes.

Suitable ovens for drying, baking and toasting the shredded product include Proctor & Schwartz, Werner Lahara and Spooner ovens containing forced air and gas fired burners and a conveyor.

The moisture of the biscuits going into the oven is usually ≈45% and the final moisture content coming out of the oven is ≈4%.

If desired, the present cereal compositions can be fabricated into presweetened cereals such as by the topical application of a conventional sweetener coating. Both conventional sugar coatings and coatings employing high potency sweeteners, especially sucralose, aspartame and potassium acesulfame, are known and can be used (as well as other high intensity sweeteners) to provide presweetened cereals for use herein. In certain variations, the coating can include other flavors, e.g., honey, vanilla, nut flavors; a confectionery fat or chocolate; cinnamon, a powdered sugar coating, e.g., flavored with ground cinnamon, or non-nutritive sweetener blend etc.). Multiple coatings can be employed. Well known compositions and pre-sweetener coating application techniques can be employed both for sugar coating or when various high potency sweeteners, e.g., aspartame, sucralose, or potassium acetylsulfame are used. In more preferred embodiments, the pre-sweetening coating comprises sugar and/or corn syrup, a flavor constituent, oil and/or vitamins. In one variation, the topical sugar coating can be fortified with a soluble fiber such as polydextrose and/or inulin (See, for example, U.S. Pat. No. 6,149,965 “Cereal Products with Inulin and Methods of Preparation” issued Nov. 21, 2000 to Bernhard van Lingerich et al.).

Methods 10 can thus employ the step of coating 80 the baked high fiber whole wheat shredded biscuits 72 with a topical coating. If employed, the topical sweetening is applied in sufficient amounts such that after drying to remove added moisture associated with the sugar coating solution, the sugar coating is present in a weight ratio of sugar coating to cereal base of ≈1:100 to ≈50:100, preferably 10:100 to ≈40:100. Typically, the sugar coating solution will have a blend of sugars and will comprise ≈4 to 20% moisture. When higher amounts of the sugar coating solution, particularly for those solutions employing higher moisture levels, the slurry coated cereal pieces can be subjected to a final or finish drying step to remove the added moisture from the sugar coating to provide finished dried products having a moisture content of ≈1 to 5%.

In preferred embodiments, the topical coating application step 80 such as a frosting coating step is practiced such as not to require or employ additional drying such as by applying a sugar coating composition 82 spraying using a compressed air 84 assist. (See, for example, the air assisted frosting application techniques described in U.S. Pat. No. 4,702,925 “Method And Apparatus For Spraying Snow-Like Frosting Onto Food Stuff Particles” Oct. 27, 1987 or U.S. Pat. No. 4,856,453 “Method And Apparatus For Spraying Snow-Like Frosting” issued Aug. 15, 1989 to Marsha K. Verrico).

In one variation, the topical sweetener coating is applied to only one major surface of spoon sized biscuits.

The products can be fabricated into bite sized pieces of convenient size and shape. Good results are obtained when a quantity of pieces has piece count of ≈6 to 20 per 10 g. In one preferred variation, the bite size pieces are in the form of biscuits or pillows that are square or rectilinear. Preferred for use herein are pieces further characterized by low aspect ratios, e.g. less than 3:1 of longest to shortest dimension, especially those of regular shapes, e.g., cubes, disks or cylinders, parallelograms or biscuits although other more complex shapes are contemplated. Of course, smaller or larger sized pieces (such as for grain based snacks) can be practiced. Uncoated pieces having the good piece count range are characterized by a bulk density of ≈0.06 to 0.4 g/cc, preferably ≈0.1 to 0.25 g/cc. In one specific embodiment, the biscuits are rectilinear having a length of ≈20-30 mm and a width of ≈15-25 mm and a height of ≈5-10 mm.

The high fiber shredded wheat cereals of the present invention can be consumed in a conventional manner to obtain the nutritional and physiological benefits of a high soluble fiber cereal food. A surprising advantage of the present R-T-E cereals is that the fiber is nearly “invisible,” that is, even high levels of fiber are barely organoleptically discernible in the finished product.

The cereal pieces can additionally comprise or be blended with various particulates intermixed with the layers as further described below. In still other variations, the cereal pieces can include one or more low moisture layers of non-cereal material such as granular sugar, freeze-dried fruit, a dried fruit puree (See, for example, U.S. Pat. No. 4,696,825 “Continuous Production of Shelf Stable Mult-Textured Shredded Cereal Biscuits Having a paste Filling” issued Sep. 29, 1987 to Leibfred), a chocolate layer, a crème filling layer (e.g., a mixture of fat and sugar), a peanut butter layer and mixtures thereof. In still other variations particulates such as raisins, aerated confections, nut pieces, dried fruit pieces, nuggets, can be blended to form various breakfast cereal products. In one variation, the fruit filling can be fortified with a soluble fiber such as inulin and/or polydextrose to provide even higher levels of fiber addition.

The finished cereal products 88 can be packaged in conventional food packages or containers and distributed in conventional form. One popular form is of a paperboard rectangular carton having an inner sealed bag fabricated from a flexible packaging film within which the present improved whole wheat shredded breakfast cereal is disposed.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method for manufacturing a visually appealing high fiber whole grain shredded wheat breakfast cereal food product, comprising the steps of:
A. cooking whole wheat kernels having a starchy endosperm and native insoluble fiber content of up to ≈14% with water to at least substantially gelatinize the starchy endosperm to provide a cooked whole wheat kernels containing from ≈28% to ≈55% moisture;
B. tempering the cooked whole wheat for a period of from 0 to ≈12 hours under ambient temperature and pressure conditions to provide tempered cooked whole wheat;
C. admixing a milled bran fiber ingredient to the tempered cooked whole wheat to provide a bran and whole wheat blend in amounts sufficient to provide a total insoluble fiber content of ≈15%-40% (dry basis);
D. shaping the blend into a desired configuration; and,
E. baking or toasting the shaped, tempered whole wheat food product to form a dried high fiber whole grain shredded wheat breakfast cereal food product.

2. The method of claim 1 wherein at least a majority of the milled bran fiber is derived from maize (corn).

3. The method of claim 2 wherein the milled bran fiber is heat treated to provide a stabilized bran fiber.

4. The method of claim 3 wherein of the milled fiber has a particle size ranging from ≈20-1000 microns.

5. The method of claim 3 wherein of the milled fiber has a particle size ranging from ≈20-100 microns.

6. The method of claim 5 wherein in step D, the chilled tempered whole wheat is formed into the shape of a biscuit having opposed major surfaces.

7. The method of claim 5 wherein the biscuit is bite sized having a piece count of ≈6-20 per 10 g.

8. The R-T-E cereal pieces of claim 7 additionally comprising a topical coating.

9. The method of claim 6 wherein the topical coating includes inulin or polydextrose.

10. The method of claim 8 wherein at least a portion of the topical coating includes a chocolate flavoring.

11. The method of claim 8 wherein the topical coating is applied to only one major surface of the biscuits.

12. The method of claim 6 wherein the wheat is white wheat and the milled bran is corn bran.

13. The method of claim 6 wherein the chilled tempered whole wheat is formed into the shape of a shredded wheat biscuit having opposed major surfaces.

14. The method of claim 6 wherein the chilled tempered whole wheat is formed into the shape of a grid patterned wheat biscuit having opposed major surfaces.

15. The method of claim 6 adding additionally comprising the step of adding a fruit filling to the centre of the biscuit.

16. The method of claim 15, wherein the fruit filling is fortified with a soluble fiber.

17. The method of claim 16 wherein at least a portion of the soluble fiber in the fruit filling is inulin or polydextrose.

18. The method of claim 7 wherein the biscuits have a length of ≈20-30 mm and a width ranging from ≈15-25 mm.

19. The method of claim 18 wherein the shaping step includes the sub-steps of shredding the blend into a continuous mat, and forming the mat into individual biscuits.

20. The method of claim 19 wherein in step C, the blend has a moisture content of ≈39-43%.

21. The method of claim 16 wherein the method further includes the step of:
providing a topical coating to the product.

22. The product prepared by the method of claim 1.

23. The product prepared by the method of claim 7.

24. The product prepared by the method of claim 8

25. The product prepared by the method of claim 12.
